(19) United States
(12) Patent Application Publication
(10) Pub. No.: US 2014/0022269 A1
(43) Pub. Date: Jan. 23, 2014

(54) METHOD AND DEVICE FOR OBTAINING SCREENSHOTS FROM MOBILE TERMINALS

(71) Applicant: Tencent Technology (Shenzhen) Company Limited, Shenzhen (CN)

(72) Inventor: Xiao Sheng ZHENG, Shenzhen (CN)

(73) Assignee: Tencent Technology (Shenzhen) Company Limited, Shenzhen (CN)

(21) Appl. No.: 14/032,117

(22) Filed: Sep. 19, 2013

Related U.S. Application Data
(63) Continuation of application No. PCT/CN2013/079195, filed on Jul. 11, 2013.

(30) Foreign Application Priority Data
Jul. 18, 2012 (CN) 2012102491808

(51) Int. Cl. G09G 5/00

(52) U.S. Cl. CPC G09G 5/001
USPC 345/545

(57) ABSTRACT

A method of obtaining a screenshot from a mobile terminal comprises: obtaining a command to obtain the screenshot; copying content from a graphics card's cache to generate a graphics card cache file; reading pixel data in the graphics card cache file to generate a bitmap. The screenshot obtaining method is not restricted or limited by the version of the operating system. In addition, the present disclosure provides a screenshot obtaining device.

### CROSS REFERENCE TO RELATED APPLICATION

This application is a U.S. continuation application filed under 35 U.S.C. §111(a) claiming priority under 35 U.S.C. §§120 and 365(c) to International Application No. PCT/CN2013/079195 filed Jul. 11, 2013, which claims the priority benefit of Chinese Patent Application No. 201210249180.8 filed Jul. 18, 2012, the contents of which are incorporated by reference herein in their entirety for all intended purposes.

### TECHNICAL FIELD

The present disclosure relates generally to the technological field of the computers, and more particularly, to a method and device for obtaining screenshots from mobile terminals.

### BACKGROUND

With the rapid development of mobile phones and other mobile terminal technologies, the functions of mobile terminals (also referred to as mobile devices) have become increasingly richer. When using mobile terminals, users often wish to capture the entire screen content for editing or sharing, a function which is often referred to as obtaining a screenshot of a mobile phone. For traditional mobile terminals, the function of obtaining screenshots usually comes from the operating systems of the mobile terminals. For example, for mobile phones with Android system, only those which have installed version 4.0 or above of the Android operating system can perform the function of obtaining screenshots. Therefore, traditional methods of obtaining screenshots are restricted and limited by the version of the operating system.

### SUMMARY OF THE DISCLOSURE

In light of the restrictions and limitations of obtaining screenshots imposed by the version of the operating system, the present disclosure provides a method of obtaining screenshots from mobile terminals that can be used in various versions of operating systems.

A method of obtaining a screenshot from a mobile terminal can comprise: obtaining a command to obtain the screenshot; copying content from a graphics card's cache to generate a graphics card cache file; and reading pixel data in the graphics card cache file to generate a bitmap.

In addition, the present disclosure provides a screenshot obtaining device that can be used in various versions of operating systems.

A screenshot obtaining device can comprise: a graphics card cache obtaining module that obtains a command to obtain a screenshot, copies content from a graphics card's cache, and generates a graphics card cache file; and a graphics card cache conversion module that reads pixel data in the graphics card cache file and generates a bitmap.

In the above method and device for obtaining screenshots from mobile terminals, content of a graphics card's cache is obtained after obtaining a command to obtain a screenshot, thereby generating a graphics card cache file. Pixel data in the graphics card cache file can be read and a bitmap can be generated. The method and the device can each be used in any version of operating systems for mobile terminals. The functionality of obtaining screenshots from mobile terminals is no longer restricted or limited by the version of the operating system.

### BRIEF DESCRIPTION OF THE DRAWINGS

FIG. 1 is a schematic diagram illustrating an example of the flow of a method of obtaining a screenshot from a mobile terminal according to various embodiments.

FIG. 2 is a schematic diagram illustrating an example of an arrangement of a screenshot obtaining device according to various embodiments.

FIG. 3 is a schematic diagram illustrating an example of an arrangement of a screenshot obtaining device according to various embodiments.

FIG. 4 is a schematic diagram illustrating an example of an arrangement of a screenshot obtaining device according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

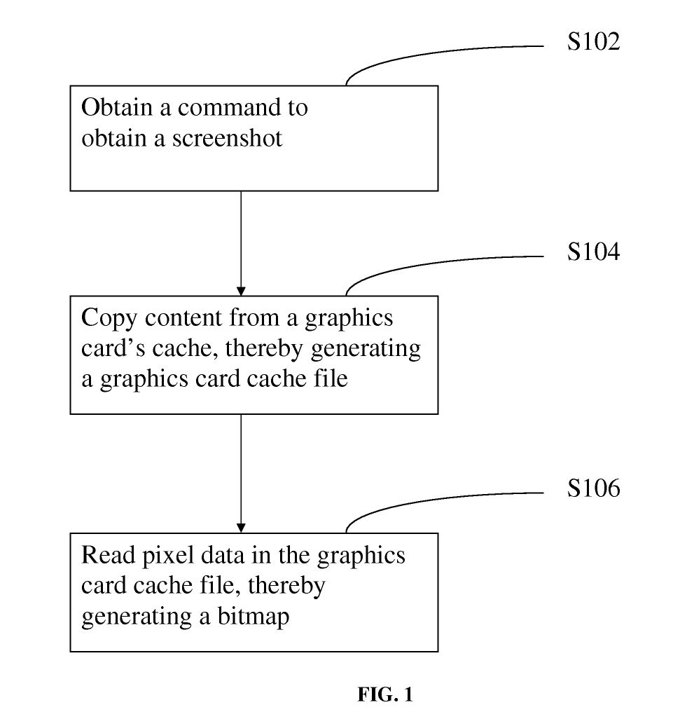

FIG. 1 is a schematic diagram illustrating an example of the flow of a method of obtaining a screenshot from a mobile terminal according to various embodiments. The method can comprise:

Step S102: obtaining a command to obtain a screenshot.

According to some embodiments, the command to obtain a screenshot can be obtained by activating a physical button or a virtual button. According to some embodiments, a physical button can be a particular preset button on a mobile terminal. According to these embodiments, when pressing that button, a command to obtain a screenshot can be obtained. According to some embodiments, a virtual button can be a particular preset button on the desktop or application interface of a mobile terminal. According to these embodiments, when pressing that button, a command to obtain a screenshot can be obtained.

According to some embodiments, a command to obtain a screenshot can be generated by obtaining a shaking operation on a mobile terminal. According to some embodiments, an acceleration sensor can be set up on a mobile terminal to detect the acceleration data of the mobile terminal in multiple directions. When the acceleration data is detected to be within a preset range, a shaking operation on the mobile terminal is obtained, thereby generating a command to obtain a screenshot.

Compared with traditional methods of triggering the obtaining of a screenshot which require a combination of multiple buttons (for example, for a traditional mobile phone which is based on Android platform, both power button and sound button have to be pressed simultaneously to trigger the obtaining of a screenshot), generating a command to obtain a screenshot through the activation of a physical button or a virtual button, or by shaking a mobile terminal, can simplify the operation and enhance the convenience of operation.

Step S104: copying content from a graphics card's cache to generate a graphics card cache file.

According to some embodiments, step S104 can comprise: obtaining a root authorization of a mobile terminal, and copying the content from the graphics card's cache to a corresponding path in a memory card of the mobile terminal.

Some commands can only be executed on a mobile terminal with a root authorization. The so-called “root” is the sole super user in an operating system of a mobile terminal, with all the authorizations in the operating system. Regarding a mobile terminal with a root authorization, a super user can access and modify almost all the files in it, for example, copy content from the graphics card's cache.

The current screen content of a mobile terminal can be stored in a graphics card's cache. According to some embodiments, a user can obtain a root authorization of a mobile terminal, and execute on the mobile terminal a copying command comprising address of the graphics card's cache and path of a memory card. Content from the graphics card's cache can be copied to a location in the memory card that corresponds to the path of the memory card. By way of example only, in a mobile terminal which is based on Android platform, if the address of the graphics card's cache is dev/graphics/fb0, then when executing a “cat” command on the mobile terminal with a root authorization, i.e. “cat/dev/graphics/fb0 path”, wherein “path” is the path of a memory card, the content from the graphics card's cache can be copied to a location in the memory card that corresponds to the “path.”

According to some embodiments, obtaining a root authorization of a mobile terminal can comprise: showing an authorization confirmation interface, and obtaining an operation confirmation command through the authorization confirmation interface.

According to these embodiments, after executing the copying command, an authorization confirmation interface can be shown, on which a confirmation button can be displayed. When pressing the confirmation button, an operation confirmation command can be obtained, which signifies the opening of permission for an application copying the content from the graphics card's cache, and allowing the execution of the copying command, i.e. the root authorization is obtained. According to some embodiments, the content from a graphics card's cache can be copied to a memory card in accordance with a copying command. The generated graphics card cache file can preserve pixel data of the current screen content, and the graphics card cache file can be stored in a location in the memory card that corresponds to the path of the memory card.

By showing an authorization confirmation interface, copying can occur after an operation confirmation command is obtained through the authorization confirmation interface, thereby allowing a user to confirm the opening of permission for copying the content from a graphics card's cache, which can enhance security.

Step S106: reading pixel data in the graphics card cache file to generate a bitmap.

According to some embodiments, step S106 can comprise: reading the graphics card cache file, and saving its pixel data to a bitmap file, thereby generating the bitmap.

According to some embodiments, a graphics card cache file can be put in a buffer first, followed by reading the pixel data in the graphics card cache file from the buffer. The read pixel data can then be saved to a bitmap file, thereby generating a bitmap. The generated bitmap can be saved as an image file and stored in a memory card.

By way of example only, in a mobile terminal which is based on Android platform, a graphics card cache file can be read into a File Input Stream, and the File Input Stream can be written into a buffer, for example, a byte buffer. According to some embodiments, pixel data in a byte buffer can be saved in a bitmap by using a bitmap copying tool such as copyPixelsFromBuffer, thereby generating a bitmap.

After obtaining a command to obtain a screenshot, by copying content from a graphics card's cache to a memory card, and reading pixel data in the graphics card cache file which is stored in the memory card, a bitmap can be generated, thereby capturing the current screen content of a mobile terminal. This method is versatile and not limited by the version of the operating system.

According to some embodiments, after generating a bitmap, image format and/or compression ratio can also be obtained. The bitmap can then be processed in accordance with the obtained image format and/or compression ratio.

According to some embodiments, after generating a bitmap, an image setting interface can be shown, through which entered image format and/or compression ratio can be received. According to some embodiments, an image setting interface can provide multiple image format options and/or multiple compression ratio options for selection. For example, an image setting interface can provide multiple image format options comprising jpg and png, and/or multiple compression ratio options comprising 50, 80 and 100 (the greater the value, the higher the resolution of an image) for a user to select.

According to some embodiments, by receiving through an image setting interface an image format and/or a compression ratio selected by a user, a bitmap can be processed in accordance with the selected image format and/or compression ratio. The processed image can then comply with the selected image format and/or compression ratio. By way of example only, in a mobile terminal which is based on Android platform, selected image format and/or compression ratio can be transmitted to the Bitmap.compress method on Android platform, through which a bitmap can be processed.

Compared with traditional methods which can only provide single-format images, by processing a bitmap, images with multiple formats and/or different resolutions can be obtained. This method of obtaining a screenshot provides more flexibility and can meet a user's customized need.

According to some embodiments, after the step of processing a bitmap, the processed image can also be saved, and displayed by invoking an image display control.

By way of example only, in a mobile terminal which is based on Android platform, a processed image can be saved in a memory card through a File Output Stream. According to some embodiments, an image display control on Android platform can be invoked to display the processed image, and the display can be ended after a preset time (for example, 2 seconds).

After processing a bitmap, an image display control can be invoked to display the processed image, achieving an online preview function, thereby allowing an instant viewing of the processed image and providing a more flexible user experience.

According to some embodiments, after processing a bitmap, an image viewing command can also be obtained. By invoking an image browsing application program and transmitting to it the access address of a processed image, the processed image which corresponds to that access address can be displayed through the image browsing application program.

According to some embodiments, after processing a bitmap, an image viewing port can be set up on the current application interface. For example, an image viewing button can be displayed on the current application interface, and an image viewing command can be obtained by pressing that button. According to some embodiments, an image browsing application program can be invoked in accordance with the image viewing command. If there are currently at least two image browsing application programs available for invoking, a dialog box can be popped up showing a list of the image browsing application programs for a user to select one. According to some embodiments, after transmitting the access address of the processed image to an image browsing application program selected by a user, the corresponding processed image saved in a memory card can be obtained in accordance with the access address and displayed through the selected image browsing application program.

By way of example only, in a mobile terminal which is based on Android platform, after obtaining an image viewing command, an Intent request can be made (on Android platform, Intent provides a common messaging system which allows the transmitting of Intent among application programs to execute actions and create events), in which a requirement to filter image file preview functions can be added, thereby filtering out application programs in the mobile terminal that can preview images. Intent can then obtain the Universal Resource Identifier (“URI”) of the processed image, and send it to an image browsing application thus filtered out that can preview images. Because the access address of the image is recorded in the URI, the image browsing application program can display the image immediately upon receiving the URI of the image.

By setting up an image viewing port on an application interface, an image browsing application can be invoked to display a processed image, thereby achieving an online preview function for the processed image, which facilitates a user's viewing of the processed image. Besides, by triggering an image viewing command, an image browsing application can be invoked to display current processed images in real time. A user does not need to find the location in a memory card where the image is stored before opening the image to view it, thereby simplifying user operation.

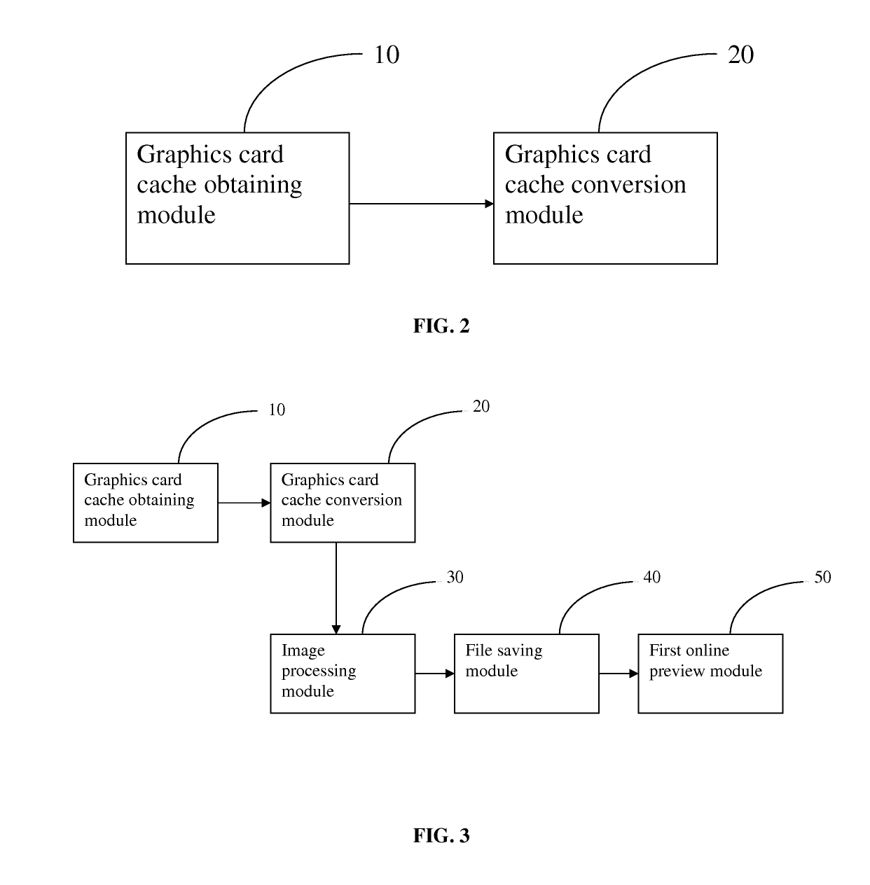

FIG. 2 is a schematic diagram illustrating an example of an arrangement of a screenshot obtaining device according to various embodiments. The device can comprise a graphics card cache obtaining module 10 and a graphics card cache conversion module 20, wherein:

The graphics card cache obtaining module 10 obtains a command to obtain a screenshot, copies content from a graphics card's cache, and generates a graphics card cache file; and

The graphics card cache conversion module 20 reads pixel data in the graphics card cache file and generates a bitmap.

According to some embodiments, the command to obtain a screenshot can be obtained by activating a physical button or a virtual button. The graphics card cache obtaining module 10 can be used to obtain the command. According to some embodiments, a physical button can be a particular preset button on a mobile terminal, and a virtual button can be a particular preset button on the desktop or application interface of a mobile terminal.

According to some embodiments, the graphics card cache obtaining module 10 can be used to obtain a command to obtain a screenshot associated with shaking a mobile terminal. According to some embodiments, an acceleration sensor can be set up on a mobile terminal to detect the acceleration data of the mobile terminal in multiple directions. When the acceleration data is detected to be within a preset range, the graphics card cache obtaining module 10 can be notified.

According to some embodiments, the graphics card cache obtaining module 10 can be used to obtain a root authorization of a mobile terminal, and copy content from the graphics card's cache to a corresponding path in a memory card of the mobile terminal.

Some commands can only be executed on a mobile terminal with a root authorization. The so-called “root” is the sole super user in an operating system of a mobile terminal, with all the authorizations in the operating system. Regarding a mobile terminal with a root authorization, a super user can access and modify almost all the files in it, for example, copy content from the graphics card's cache.

The current screen content of a mobile terminal can be stored in the graphics card's cache. According to some embodiments, the graphics card cache obtaining module 10 can be used to obtain a root authorization of a mobile terminal. By executing a copying command comprising the address of the graphics card's cache and the path of a memory card, content from the graphics card's cache can be copied to a location in the memory card that corresponds to the path of the memory card.

According to some embodiments, the graphics card cache obtaining module 10 can be used to show an authorization confirmation interface, through which an operation confirmation command can be obtained.

According to these embodiments, after the copying command is executed by the graphics card cache obtaining module 10, an authorization confirmation interface can be shown, on which a confirmation button can be displayed. When pressing the confirmation button, an operation confirmation command is obtained by the graphics card cache obtaining module 10, which signifies the opening of permission for an application copying content from the graphics card's cache, and allowing the execution of the copying command, i.e. the graphics card cache obtaining module 10 has obtained the root authorization. According to some embodiments, the graphics card cache obtaining module 10 can copy content from the graphics cards' cache to a memory card in accordance with the copying command. The generated graphics card cache file can preserve pixel data of the current screen content, and the graphics card cache file can be stored in a location in the memory card that corresponds to the path of the memory card.

According to some embodiments, the graphics card cache conversion module 20 can be used to read a graphics card cache file and save its pixel data to a bitmap file, thereby generating a bitmap.

According to some embodiments, the graphics card cache conversion module 20 can be used to put a graphics card cache file in a buffer first, and then read pixel data in the graphics card cache file from the buffer. The read pixel data can then be saved to a bitmap file by the graphics card cache conversion module 20, thereby generating a bitmap. The generated bitmap can be saved as an image file and stored in a memory card.

FIG. 3 is a schematic diagram illustrating an example of an arrangement of a screenshot obtaining device according to various embodiments. In addition to the modules illustrated in FIG. 2, the device can further comprise: an image processing module 30, a file saving module 40 and a first online preview module 50, wherein:

The image processing module 30 obtains an image format and/or a compression ratio, and processes the bitmap in accordance with the obtained image format and/or compression ratio.

According to some embodiments, the image processing module 30 can show an image setting interface, and receive entered image format and/or compression ratio via the image setting interface. According to some embodiments, an image setting interface can provide multiple image format options and/or multiple compression ratio options for selection. For example, an image setting interface can provide multiple image format options comprising jpg and png, and/or multiple compression ratio options comprising 50, 80 and 100 (the greater the value, the higher the resolution of an image) for a user to select.

According to some embodiments, the image processing module 30 can be used to receive an image format and/or a compression ratio selected by a user, and process a bitmap in accordance with the selected image format and/or compression ratio. The processed image can then comply with the selected image format and/or compression ratio.

The file saving module 40 saves a processed image.

The first online preview module 50 invokes an image display control to display a processed image.

According to some embodiments, after invoking an image display control by the first online preview module 50 to display a processed image, the display can be ended after a preset time (for example, 2 seconds).

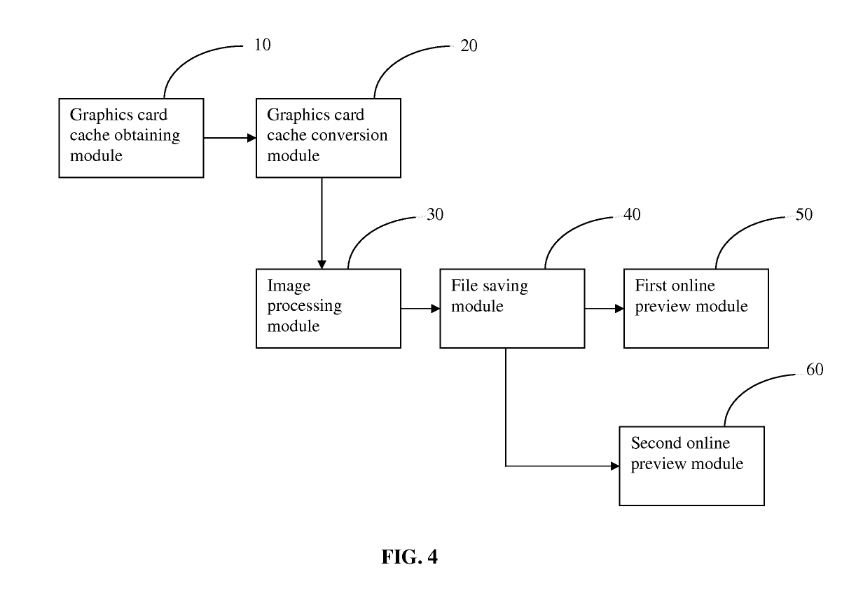

FIG. 4 is a schematic diagram illustrating an example of an arrangement of a screenshot obtaining device according to various embodiments. In addition to the modules illustrated in FIG. 3, the device can further comprise a second online preview module 60 that obtains an image viewing command, invokes an image browsing application program, sends an access address of a processed image to the image browsing application program, and displays the processed image which corresponds to the access address through the image browsing application program.

According to some embodiments, the second online preview module 60 can be used to set up an image viewing port on the current application interface. For example, an image viewing button can be displayed on the current application interface, and an image viewing command can be obtained by pressing the button. According to some embodiments, the second online preview module 60 can be used to invoke an image browsing application program in accordance with the image viewing command. If there are currently at least two image browsing application programs available for invoking, a dialog box can be popped up showing a list of the image browsing application programs for a user to select one.

According to some embodiments, the second online preview module 60 can be used to send an access address of a processed image to an image browsing application program selected by a user. The corresponding processed image saved in a memory card can be obtained in accordance with the access address, and displayed through the image browsing application program.

The devices for obtaining a screenshot in the various embodiments described hereinabove can be run on mobile terminals. A mobile terminal can be a mobile phone, a tablet PC, a media player, etc. Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), a media player (including, but not limited to, Apple iPod and Microsoft Zoom), or an on-vehicle device running any of the above-mentioned operating systems or any other operating systems, all of which are well known to those skilled in the art.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A method of obtaining a screenshot from a mobile terminal, comprising:
obtaining a command to obtain the screenshot,
copying content from a graphics card's cache to generate a graphics card cache file, and
reading pixel data in the graphics card cache file to generate a bitmap.

2. The method of claim 1, wherein obtaining a command to obtain the screenshot comprises at least one step selected from the group consisting of: activating a physical button, activating a virtual button, and shaking the mobile terminal.

3. The method of claim 1, wherein copying content from a graphics card's cache comprises:
obtaining a root authorization of the mobile terminal, and
copying content from the graphics card's cache to a corresponding path in a memory card of the mobile terminal.

4. The method of claim 3, wherein obtaining a root authorization of the mobile terminal comprises:
showing an authorization confirmation interface, and
obtaining an operation confirmation command through the authorization confirmation interface.

5. The method of claim 1, wherein reading pixel data in the graphics card cache file comprises:
reading the graphics card cache file, and
saving the pixel data in the graphics card cache file to a bitmap file.

6. The method of claim 1, comprising:
obtaining an image format, and
processing the bitmap in accordance with the obtained image format to obtain a processed image.

7. The method of claim 6, comprising:
saving the processed image, and
invoking an image display control to display the processed image.

8. The method of claim 6, comprising:
obtaining an image viewing command,
invoking an image browsing application program,
sending to the invoked image browsing application program an access address of the processed image, and
displaying the processed image corresponding to the access address through the image browsing application program.

9. The method of claim 1, comprising:
obtaining a compression ratio, and
processing the bitmap in accordance with the obtained compression ratio to obtain a processed image.

10. The method of claim 9, comprising:
saving the processed image, and
invoking an image display control to display the processed image.

11. The method of claim 9, comprising:
obtaining an image viewing command,
invoking an image browsing application program,
sending to the invoked image browsing application program an access address of the processed image, and
displaying the processed image corresponding to the access address through the image browsing application program.

12. A screenshot obtaining device comprising:
a graphics card cache obtaining module that obtains a command to obtain a screenshot, copies content from a graphics card's cache, and generates a graphics card cache file, and
a graphics card cache conversion module that reads pixel data in the graphics card cache file and generates a bitmap.

13. The device of claim 12, wherein the command is associated with an action comprising at least one step selected from the group consisting of: activating a physical button, activating a virtual button, and shaking a mobile terminal.

14. The device of claim 12, wherein the graphics card cache obtaining module obtains a root authorization of a mobile terminal and copies content from the graphics card's cache to a corresponding path in a memory card of the mobile terminal.

15. The device of claim 14, wherein the graphics card cache obtaining module shows an authorization confirmation interface and obtains an operation confirmation command through the authorization confirmation interface.

16. The device of claim 12, wherein the graphics card cache conversion module reads the graphics card cache file and saves pixel data in the graphics card cache file to a bitmap file.

17. The device of claim 12, comprising:
an image processing module that obtains an image format and processes the bitmap in accordance with the obtained image format, thereby obtaining a processed image.

18. The device of claim 17, comprising:
a file saving module that saves the processed image, and
a first online preview module that invokes an image display control to display the processed image.

19. The device of claim 12, comprising:
an image processing module that obtains a compression ratio and processes the bitmap in accordance with the obtained compression ratio, thereby obtaining a processed image.

20. The device of claim 19, comprising:
a file saving module that saves the processed image, and
a first online preview module that invokes an image display control to display the processed image.
